(19) United States
(12) Patent Application Publication
(10) Pub. No.: US 2024/0235265 A1
(43) Pub. Date: Jul. 11, 2024

(54) CONTROL METHOD FOR WIRELESS CHARGING, AND WIRELESS CHARGING APPARATUS AND SYSTEM

(71) Applicant: AcLeap Power Inc., Taipei City (TW)

(72) Inventors: Qixue Yu, Shanghai (CN); Lishen Zhou, Shanghai (CN); Qin Sun, Shanghai (CN)

(21) Appl. No.: 18/406,648

(22) Filed: Jan. 8, 2024

(30) Foreign Application Priority Data
Jan. 9, 2023 (CN) 202310037634.3

(51) Int. Cl. H02J 50/12; H02J 7/00

(52) U.S. Cl. CPC H02J 50/12; H02J 7/0047; H02J 7/00712; H02J 7/007192; H02J 2207/20

(57) ABSTRACT

Embodiments of the present disclosure provide a control method for wireless charging, a wireless charging apparatus and a wireless charging system. The control method includes: controlling a first power converter at a secondary side to charge a chargeable load at a first set current; receiving a sensing signal representing an output current of a second power converter at a primary side; and in response to the output current reaching or exceeding a threshold current, controlling the first power converter to charge the chargeable load at a second set current smaller than the first set current. The scheme of the present disclosure may implement power derating of the wireless charging system and ensure that the primary-side components of the system operate within the safety range.

### CROSS-REFERENCE TO RELATED APPLICATIONS

This application claims priority to Chinese Patent Application No. 202310037634.3, filed Jan. 9, 2023, and titled CONTROL METHOD FOR WIRELESS CHARGING, AND WIRELESS CHARGING DEVICE AND SYSTEM, which is hereby incorporated by reference in its entirety.

### BACKGROUND

Embodiments of the present disclosure relate to the field of wireless charging technology, and more specifically, to a control method for wireless charging, a wireless charging apparatus and a wireless charging system comprising the wireless charging apparatus.

The wireless charging technology is extensively applied in various industrial fields due to its convenience and safety. For example, in automatic guided vehicle (AGV) for logistics and transportation, on-board batteries thereof may be charged in a wireless manner. Accordingly, the charging circuit layout and connection are no longer needed, the possible interference and safety hazards brought by the wiring are avoided, and the on-site automatic level is also improved.

To ensure reliability and safety, the wireless charging device is usually operated according to a rated power during the charging process. Moreover, in some cases, e.g., in case of rise of the ambient temperature, the wireless charging device is required to derate the power to prevent the internal devices, such as the power switching device, from operating beyond the safety range. However, in certain wireless charging scenarios, it is often hard to position the secondary-side coil and the primary-side coil at ideal positions with respect to each other. For example, the AGV, when in need of charging, may randomly stop at a position above or near the charging pad, rather than accurately stop at an optimal position or a fixed position for charging. As such, there is uncertainty in the coupling relation between the primary-side coil and the secondary-side coil, which may impact the implementation of power derating and shorten the service life of the internal devices like the power switching device or even cause damage.

### BRIEF DESCRIPTION

In view of the above problems, there is provided a control method for wireless charging, a wireless charging apparatus and a wireless charging system comprising the wireless charging apparatus in accordance with example implementations of the present disclosure.

In a first aspect of the present disclosure, there is provided a control method for wireless charging. The control method includes: controlling a first power converter at a secondary side to charge a chargeable load at a first set current; receiving a sensing signal representing an output current of a second power converter at a primary side; and in response to the output current reaching or exceeding a threshold current, controlling the first power converter to charge the chargeable load at a second set current smaller than the first set current.

In some embodiments of the present disclosure, the control method further includes: in response to the output current below the threshold current, controlling the first power converter to keep charging the chargeable load at the first set current.

In some embodiments of the present disclosure, the control method further includes: obtaining, based on the sensing signal, a quasi-peak value signal or a half-wave average signal corresponding to the sensing signal; and determining, based on the quasi-peak value signal or the half-wave average signal, the output current of the second power converter.

In some embodiments of the present disclosure, determining, based on the quasi-peak value signal or the half-wave average signal, the output current of the second power converter includes: sampling the quasi-peak value signal or the half-wave average signal to determine a maximum value; and determining, based on the maximum value, the output current of the second power converter.

In some embodiments of the present disclosure, receiving the sensing signal representing the output current of the second power converter at the primary side includes: receiving from a first current sensing device the sensing signal, wherein the first current sensing device is configured to sense a current in an output branch of the second power converter.

In some embodiments of the present disclosure, the second power converter is a single-phase full-bridge converter, and receiving the sensing signal representing the output current of the second power converter at the primary side includes: receiving from a second current sensing device and a third current sensing device the sensing signal, wherein the second current sensing device is configured to sense a current in an upper bridge arm or a lower bridge arm of a first bridge arm of the single-phase full-bridge converter, and the third current sensing device is configured to sense a current in the lower bridge arm or the upper bridge arm of the first bridge arm, or sense a current in an upper bridge arm or a lower bridge arm of a second bridge arm of the single-phase full-bridge converter.

In some embodiments of the present disclosure, the control method further includes: adjusting the threshold current based on ambient conditions.

In some embodiments of the present disclosure, the ambient conditions include ambient temperature.

In some embodiments of the present disclosure, a charging coil at the secondary side is electromagnetically coupled to a charging coil at the primary side in a loose manner.

In a second aspect of the present disclosure, there is provided a wireless charging apparatus, including: a charging coil for electromagnetically coupling to a primary-side charging coil at a secondary side; a first power converter; and a control device for controlling the first power converter, wherein the control device is configured to: control the first power converter to charge a chargeable load at a first set current; receive a sensing signal representing an output current of a second power converter at a primary side; and in response to the output current reaching or exceeding a threshold current, control the first power converter to charge the chargeable load at a second set current smaller than the first set current.

In some embodiments of the present disclosure, the control device is further configured to: in response to the output current below the threshold current, control the first power converter to keep charging the chargeable load at the first set current.

In some embodiments of the present disclosure, the control device is further configured to: obtain, based on the sensing signal, a quasi-peak value signal or a half-wave average signal corresponding to the sensing signal; and determine, based on the quasi-peak value signal or the half-wave average signal, the output current of the second power converter.

In some embodiments of the present disclosure, determining, based on the quasi-peak value signal or the half-wave average signal, the output current of the second power converter includes: sampling the quasi-peak value signal or the half-wave average signal to determine a maximum value; and determining, based on the maximum value, the output current of the second power converter.

In some embodiments of the present disclosure, receiving the sensing signal representing the output current of the second power converter at the primary side includes: receiving from a first current sensing device the sensing signal, wherein the first current sensing device is configured to sense a current in an output branch of the second power converter.

In some embodiments of the present disclosure, the second power converter is a single-phase full-bridge converter, and wherein receiving the sensing signal representing the output current of the second power converter at the primary side includes: receiving from a second current sensing device and a third current sensing device the sensing signal, wherein the second current sensing device is configured to sense a current in an upper bridge arm or a lower bridge arm of a first bridge arm of the single-phase full-bridge converter, and the third current sensing device is configured to sense a current in the lower bridge arm or the upper bridge arm of the first bridge arm, or sense a current in an upper bridge arm or a lower bridge arm of a second bridge arm of the single-phase full-bridge converter.

In some embodiments of the present disclosure, the control device is further configured to: adjust the threshold current based on ambient conditions.

In some embodiments of the present disclosure, the ambient conditions include ambient temperature.

In some embodiments of the present disclosure, a charging coil at the secondary side is electromagnetically coupled to a charging coil at the primary side in a loose manner.

In a third aspect of the present disclosure, there is provided a wireless charging system, including: a secondary-side charging apparatus, which is the wireless charging apparatus according to the second aspect; and a primary-side charging apparatus, including: a charging coil for electromagnetically coupling to a charging coil of the secondary-side charging apparatus at a primary side; and a second power converter.

In some embodiments of the present disclosure, the wireless charging system also includes: a first current sensing device configured to sense a current in an output branch of the second power converter.

In some embodiments of the present disclosure, the second power converter is a single-phase full-bridge converter, and the wireless charging system further includes: a second current sensing device configured to sense a current in an upper bridge arm or a lower bridge arm of a first bridge arm of the single-phase full-bridge converter, and a third current sensing device configured to sense a current in the lower bridge arm or the upper bridge arm of the first bridge arm, or adapted to sense a current in an upper bridge arm or a lower bridge arm of a second bridge arm of the single-phase full-bridge converter.

It should be appreciated that the contents described in this brief description are not intended to identify key or essential features of the implementations of the present disclosure, or limit the scope of the present disclosure. Other features of the present disclosure will be understood more easily through the following description.

### BRIEF DESCRIPTION OF THE DRAWINGS

Through the following detailed description with reference to the accompanying drawings, the above and other features, advantages and aspects of various implementations of the present disclosure will become more apparent. In the drawings, the same or similar reference signs indicate same or similar elements, wherein:

FIG. 1 illustrates a schematic circuit diagram of a wireless charging system in accordance with embodiments of the present disclosure;

FIG. 2A illustrates a schematic diagrams of a primary-side compensation network in accordance with embodiments of the present disclosure;

FIG. 2B illustrates a schematic diagrams of a secondary-side compensation network in accordance with embodiments of the present disclosure;

FIG. 3 illustrates a schematic flowchart of a control method for wireless charging in accordance with embodiments of the present disclosure;

FIG. 4A illustrates a curve graph of a first charging processing in accordance with embodiments of the present disclosure;

FIG. 4B illustrates a curve graph of a second charging processing in accordance with embodiments of the present disclosure;

FIG. 5A illustrates a schematic diagram of a first arrangement of a sensing component for sensing a primary-side output current in accordance with embodiments of the present disclosure;

FIG. 5B illustrates a schematic diagram of a second arrangement of a sensing component for sensing a primary-side output current in accordance with embodiments of the present disclosure;

FIG. 5C illustrates a schematic diagram of a third arrangement of a sensing component for sensing a primary-side output current in accordance with embodiments of the present disclosure;

FIG. 5D illustrates a schematic diagram of a fourth arrangement of a sensing component for sensing a primary-side output current in accordance with embodiments of the present disclosure;

FIG. 5E illustrates a schematic diagram of a fifth arrangement of a sensing component for sensing a primary-side output current in accordance with embodiments of the present disclosure;

FIG. 6A illustrates an example schematic diagram of a quasi-peak value filter in accordance with embodiments of the present disclosure;

FIG. 6B illustrates an example schematic diagram of a half-wave average value filter in accordance with embodiments of the present disclosure;

FIG. 7 illustrates an example waveform of a quasi-peak value signal or half-wave average signal in accordance with embodiments of the present disclosure;

FIG. 8A illustrates a schematic diagram of comparison between an output current and a threshold current during part of a second charging process; and

FIG. 8B illustrates a schematic diagram of comparison between an output current and a threshold current during another part of time of a second charging process.

### DETAILED DESCRIPTION

The implementations of the present disclosure will be described below in more details with reference to the drawings. Although the drawings illustrate some implementations of the present disclosure, it should be appreciated that the present disclosure can be implemented in various manners and should not be limited to the implementations explained herein. On the contrary, the implementations are provided to enable those skilled in the art to understand the present disclosure more thoroughly and completely. It should be appreciated that the drawings and implementations of the present disclosure are exemplary only and are not intended for restricting the protection scope of the present disclosure.

In the description of implementations disclosed herein, the term “includes” and its similar expressions are to be read as open-ended terms that mean “includes, but is not limited to.” The term “based on” is to be read as “based at least in part on.” The terms “one example embodiment/implementation” and “this embodiment/implementation” are to be read as “at least one embodiment/implementation.” The terms “first”, “second” and so on can refer to same or different objects. The following text also can include other explicit and implicit definitions.

Embodiments of the present disclosure provide an improved control scheme for wireless charging. In the improved scheme, output currents of a primary-side power converter may be sensed; and in case of power derating, the set charging current at the secondary side may be controlled or reduced in accordance with the current sensing result obtained at the primary side, so as to effectively limit the output currents at the primary side below a threshold current. As such, power derating is achieved in the wireless charging systems while the safety of the wireless charging system, in particular the power switching device at the primary side, is also guaranteed.

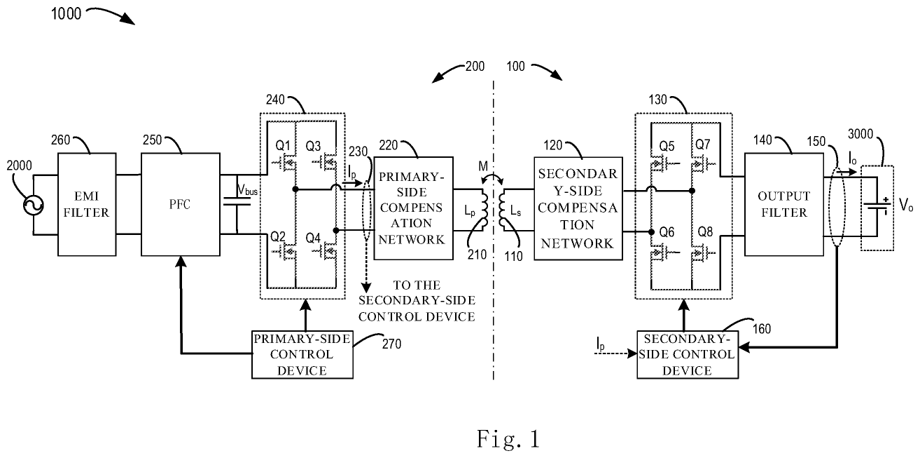

FIG. 1 illustrates a schematic circuit diagram of the wireless charging system 1000 in accordance with embodiments of the present disclosure. The wireless charging system 1000 includes a secondary-side charging apparatus 100 connected to a chargeable load 3000 and a primary-side charging apparatus 200 connected to a power supply 2000. Accordingly, the primary-side charging apparatus 200 and the secondary-side charging apparatus 100 may transmit and provide the power from the power supply 2000 to the chargeable load 3000. As an example, the power supply 2000 may be a public grid and the chargeable load 3000 may be a chargeable battery, wherein the chargeable battery for example may be a single battery or a set of batteries connected in series, parallel or series-parallel. It is to be understood that implementations of the power supply 2000 and the chargeable load 3000 are not limited to this, and they may be other types of DC or AC power supplies and other types of chargeable loads (such as super-capacitor), or combinations of various types of power supplies and combinations of various types of chargeable loads. In one embodiment, the secondary-side charging apparatus 100 and the chargeable load 3000 may be part of the AGV and integrated into the AGV to move along with the AGV. In addition, the primary-side charging apparatus 200 connected to the power supply 2000 may be formed into a charging board, such that the AGV may move to a position above or near the charging pad for wireless charging.

The secondary-side charging apparatus 100 may include a secondary-side charging coil 110 and a first power converter 130, and the primary-side charging apparatus 200 may include a primary-side charging coil 210 and a second power converter 240. The charging coils 110 and 210 respectively serve as receiving coil and transmitting coil for transmitting power from the primary side to the secondary side. The first power converter 130 and the second power converter 240 may implement the converting operations to obtain expected voltage and current. For example, the first power converter 130 may convert the AC power to the DC power and the second power converter 240 may converter direct currents into alternating currents. However, the first power converter 130 and the second power converter 240 also may be converters in other types depending on the actual needs.

Moreover, the primary-side charging apparatus 200 also may include a primary-side compensation network 220, a sensing component 230, a power factor correction (PFC) unit 250, an electro-magnetic interference (EMI) filter 260 and a primary-side control device 270; and the secondary-side charging apparatus 100 also may include a secondary-side compensation network 120, an output filter 140, a sensing component 150 and a secondary-side control device 160.

The sensing component 150 may sense the output voltage and/or the output current (i.e., voltage and/or current input to the chargeable load 3000) of the first power converter 130 or the output filter 140, while the sensing component 230 may sense the output voltage and/or the output current of the second power converter 240. The secondary-side control device 160 and the primary-side control device 270 can receive sensing signals or measurement results from the sensing components 150 and 230, and control the first power converter 130 and the second power converter 240. For example, the power switching devices in the power converters are controlled to perform switching-on and switching-off operations to implement the desired power conversion operations. It should be appreciated that other suitable sensing components may also be configured as required, and corresponding sensing results are provided to the secondary-side control device 160 and the primary-side control device 270 to fulfill the respective control objectives.

The secondary-side control device 160 and the primary-side control device 270 may be implemented in various ways. For example, the secondary-side control device 160 and the primary-side control device 270 may be implemented in the form of controllers having computation and processing capacity, or in the form of circuits like analog circuits and/or digital circuits, or combinations thereof. In one embodiment, the secondary-side control device 160 and the primary-side control device 270 also may be integrated into one control device. For example, the control device may be disposed at either the primary side or the secondary side, and the control device may receive sensing signals or sensing results from both sides and control the power converters at both sides. Besides, the control devices 160 and 270 also may control other units or devices in addition to the power converters 130 and 240. For example, the primary-side control device 270 also may control the PFC unit 250 in view of the requirements, to implement desired power factor correction. It is to be understood that units and devices shown in FIG. 1 are only exemplary and part(s) of the units and circuits may be added, omitted and substituted based on the actual needs. In such case, the embodiments of the present disclosure can still be implemented.

As stated above, in some cases, it is required to derate the power of the wireless charging system. For example, when the ambient temperature is normal, the system may charge at full power; as the ambient temperature rises, the power of the system should be derated, such that devices or components within the system, when operating under higher temperatures, are still safe, to avoid aging or damage. Besides, when the chargeable load is about to be fully charged, an instruction may be issued to the charging system to indicate that full power is no longer required. Instead, the final stage of charging may be completed at a relatively low power. Accordingly, the charging system also may satisfy the need of the chargeable load through power derating.

Generally, power derating may be easily implemented. For example, as the ambient temperature rises, the power derating may be achieved by lowering the set value of the charging currents output to the chargeable load while the safety of the power switching devices and other components at primary and secondary sides is guaranteed. To be specific, the total currents flowing by the primary-side power switching device usually include exciting currents and load reflection currents, where the exciting currents are constant and of a relatively small portion while the load reflection currents depend on current reflection ratio between the secondary side and the primary side and the charging currents at the secondary side. In case of a constant current reflection ratio, the load reflection currents are only associated with the charging currents. Under this circumstance, the charging currents are reduced by decreasing the set value of the charging current output to the chargeable load, so as to correspondingly reduce the load reflection currents at the primary side and further lower the total currents flowing by the primary-side power switching device. In other words, in the event that the current reflection ratio is constant, the currents flowing by both the secondary-side power switching device and the primary-side power switching device may be limited or reduced by restricting or lowering the charging currents flowing to the chargeable load. As a result, it is ensured that the power switching devices at both primary and secondary sides operate within a safety range.

However, the above case is implemented on the condition that current reflection ratio from the secondary side to the primary side is constant. In some wireless charging scenarios, the current reflection ratio may not be a constant value. For example, the AGV may randomly stop at a certain position above or near the charging pad during charging, and this position often is not the optimal charging position and differs from the previous charging position. In other words, the secondary-side charging coil may be electromagnetically coupled to the primary-side charging coil in a loose manner. On account of that, the coupling coefficient or the coupling inductance of the secondary-side charging coil and the primary-side charging coil may change frequently. Particularly, if the secondary-side charging coil and the primary-side charging coil are not aligned or a wide distance is present therebetween, the coupling coefficient or the coupling inductance would be affected clearly, resulting into significant corresponding changes in the current reflection ratio.

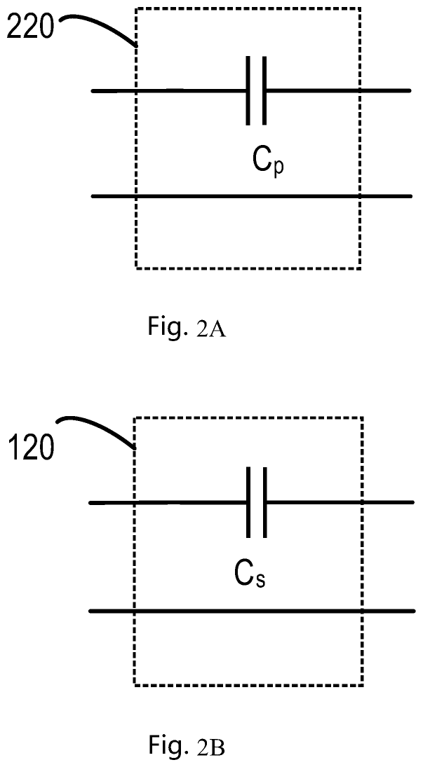

FIGS. 2A and 2B respectively illustrate schematic diagrams of the primary-side compensation network 220 and the secondary-side compensation network 120 in accordance with embodiments of the present disclosure. In the examples provided by FIGS. 2A and 2B, the primary-side compensation network 220 and the secondary-side compensation network 120 both adopt a series compensation structure, i.e., the compensation capacitance Cₚ is connected in series with the primary-side charging coil 210 as the transmitting coil at the primary side, and the compensation capacitance Cs is connected in series with the secondary-side charging coil 110 as the receiving coil at the secondary side. A network that adopts the series compensation structure at both the primary side and the secondary side is also known as PSSS (primary side series and secondary side series) compensation network. The wireless charging system using the PSSS compensation network is taken as an example to explain the influence of the coupling inductance between primary-side coil and the secondary-side coil on the current reflection ratio and the primary-side current. However, it should be understood that the following description also applies to the wireless charging system utilizing other types of compensation networks.

Studies show that when the switching frequency is equal to the resonant frequency of the PSSS compensation network, the ratio of current reflected to the primary side from the secondary side is inversely proportional to the square of the mutual inductance coefficient. In case that the distance between the primary-side coil and the secondary-side coil widens and/or mis-alignment between the primary-side coil and the secondary-side coil goes further, the mutual inductance between the primary-side coil and the secondary-side coil would decrease. As a result, the current reflection ratio inversely proportional to the square of the mutual inductance becomes larger and the reflection currents and the total currents flowing by the power switching device at the primary side further increase. In other words, the varying distances and alignments between the primary-side coil and the secondary-side coil indicate that the currents at the primary side may greatly differ even if the charging currents and the power output by the secondary side are the same. In such case, if only the charging currents output by the secondary side are limited or lowered during the power derating, it cannot be ensured that the currents at the primary side would also be restricted or lowered correspondingly. It is even possible that the currents at the primary side would increase due to the increase of the current reflection ratio. Consequently, the currents at the primary side extend beyond the safety range of the power switching devices and other components. Besides, the power could not be accurately limited on account of the complex influencing factors of the primary-side currents. Hence, it is usually impossible to limit and derate the power by the primary-side currents alone.

To solve the above issues, embodiments of the present disclosure provide an improved scheme for controlling the wireless charging. By sensing the output currents of the primary-side power converter and limiting the charging output currents at the secondary side according to the sensing signals, the derating of the charging currents may be combined with the primary-side current limitation, such that the primary-side currents may be restricted within a range that is safe for the power switching devices and other components during the power derating process. Furthermore, the power derating may be effectively implemented and the safety of the components of the wireless charging system, including the primary-side power device, is guaranteed.

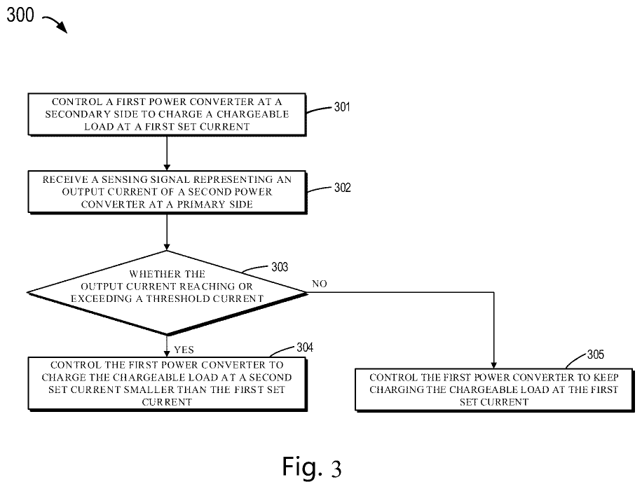

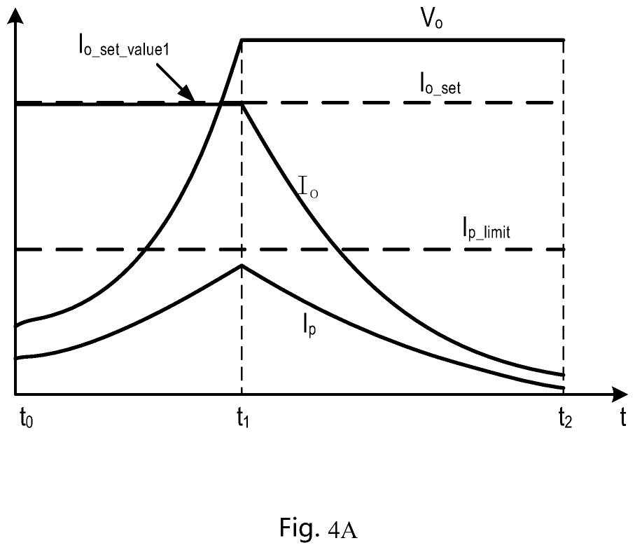

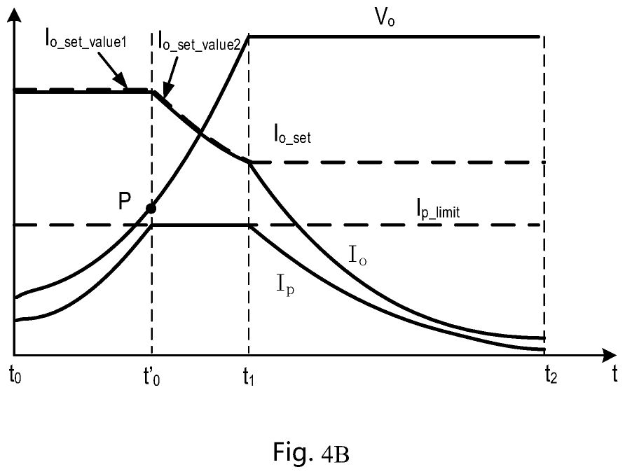

FIG. 3 illustrates a schematic flowchart of a control method 300 for wireless charging in accordance with embodiments of the present disclosure; FIG. 4A shows a curve graph of a first charging processing with the control method 300 in accordance with embodiments of the present disclosure; and FIG. 4B illustrates a curve graph of a second charging process with the control method 300 in accordance with embodiments of the present disclosure. The control method 300 may be implemented in the scenario of FIG. 1 and performed by the secondary-side control device 160 of the secondary-side charging apparatus 100 in the wireless charging system 1000. It is to be understood that in some cases, e.g., when the primary-side control device 270 can communicate with and control the secondary-side device, or an integrated control device is provided to control the devices at both primary and secondary sides, the control method 300 also may be performed in the primary-side control device 270 or the integrated control device. The above described various aspects with reference to FIG. 1 may apply to the control method 300. For the sake of discussion, the control method 300 is to be described with reference to FIGS. 1, 3, 4A and 4B.

At block 301, the secondary-side control device 160 controls the first power converter 130 at the secondary side to charge the chargeable load 3000 with a first set current I_{o_set_value1}.

As an example, the process of charging the chargeable load 3000 by the wireless charging system 1000 generally may include two phases, wherein the first phase is constant-current charging phase and the second phase following that is constant-voltage charging phase. For example, in FIGS. 4A and 4B, t₀ to t₁ indicates the constant-current charging phase, while t₁ to t₂ refers to the constant-voltage charging phase. During the constant-current charging phase (from t₀ to t₁), the secondary-side control device 160 may control the first power converter 130 to charge the chargeable load 3000 at the set current I_{o_set} as the charging current Iₒ. For example, the set current I_{o_set} may be preset as the first set current I_{o_set_value1}. The secondary-side control device 160 may receive current sensing results from the sensing component 150 and controls the ON and OFF of the power switching devices in the first power converter 130 according to a difference between the set current I_{o_set} and the current sensing results, which allows the charging current Iₒ to reach the set current I_{o_set}. The chargeable load 3000 accordingly is charged at the constant currents.

At block 302, the secondary-side control device 160 receives sensing signals representing output currents Iₚ of the second power converter 240 at the primary side.

As an example, the secondary-side control device 160 may receive from the sensing component 230 sensing signals representing output currents Iₚ of the second power converter 240. Alternatively, the sensing signals from the sensing component 230 may be transmitted to the primary-side control device 270 and passed to the secondary-side control device 160 through the communications between the primary-side control device 270 and the secondary-side control device 160. The secondary-side control device 160 may process the sensing signals to obtain the magnitude of the output current Iₚ of the second power converter 240.

At block 303, the secondary-side control device 160 determines whether the output current Iₚ reaches or exceeds a threshold current I_{p_limit}.

As an example, the threshold current I_{p_limit} may be preset according to factors including ambient conditions (e.g., ambient temperature), parameters of the power switching devices and thermal results etc., and the output current Iₚ indicated by the sensing signal may be compared with the threshold current I_{p_limit}. If the output current Iₚ is below the threshold current I_{p_limit}, it means that the currents flowing by the primary-side power switching device are within the safety range. However, if the output current Iₚ reaches or exceeds the threshold current I_{p_limit}, it means that the currents flowing by the primary-side power switching device are about to or already go beyond the safety range. In some embodiments, the secondary-side control device 160 may adjust the threshold current I_{p_limit} based on the ambient conditions. Specifically, the preset threshold current I_{p_limit} may be adjusted in real time according to the changes of the ambient conditions. For example, in case of drop of the ambient temperature, the threshold current I_{p_limit} may be raised to avoid unnecessary reduction in the set current I_{o_set}. Therefore, as much charging power as possible is output to the chargeable load 3000 during power derating.

At block 304, if the output current Iₚ reaches or exceeds the threshold current I_{p_limit}, the secondary-side control device 160 controls the first power converter 130 to charge the chargeable load 3000 at a second set current I_{o_set_value2} smaller than the first set current I_{o_set_value1}.

At block 305, if the output current Iₚ is below the threshold current I_{p_limit}, the secondary-side control device 160 controls the first power converter 130 to maintain the first set current I_{o_set_value1}, at which the chargeable load 3000 is charged.

As an example, the first charging process shown by FIG. 4A is a normal charging procedure where no power derating occurs, or a charging procedure where power derating occurs (e.g., derating the charging current Iₒ and/or output current Iₚ due to the rise of the ambient temperature) but the output current Iₚ is constantly below the threshold current I_{p_limit}. In the first charging process, the wireless charging system 1000 maintains the charging current Iₒ at the first set current I_{o_set_value1} to charge the chargeable load 3000 at a constant current during the constant-current charging phase (from t₀ to t₁). In this process, the charging voltage Vₒ applied to the chargeable load 3000 may continuously rise as the charge of the chargeable load 3000 increases, and the output current Iₚ of the second power converter 240 also gradually rises. However, the output current Iₚ is always below the threshold current I_{p_limit} during the constant-current charging phase. Accordingly, the set current I_{o_set} for the charging current Iₒ also remains unchanged and the charging current Iₒ following the set current I_{o_set} is kept constant all the time. At t₁, the constant-current charging phase ends and the wireless charging system 1000 is about to charge at constant voltage, i.e., the essentially constant charging voltage Vₒ is maintained. At the constant-voltage charging phase from t₁ to t₂, the charging currents Iₒ at the secondary side and the output currents Iₚ at the primary side gradually decrease.

Next, continue to refer to the second charging process shown in FIG. 4B, which second charging process may be a power derating charging procedure. As the ambient temperature rises or the secondary-side charging coil 110 is not aligned with the primary-side charging coil 210 or the distance therebetween is too wide, the wireless charging system 1000 derates the power and the output current Iₚ would reach or exceed the threshold current I_{p_limit}. Therefore, the second charging process is different from the first charging process. To be specific, during the constant-current charging phase (t₀ to t₁), when the charging voltage V₀ increases to P at t₀′, the primary-side output current Iₚ goes up to reach and is about to exceed the threshold current I_{p_limit}. At this point, the secondary-side control device 160 may reduce the set current I_{o_set} from the first set current I_{o_set_value1} to the second set current I_{o_set_value2}, such that the primary-side output current Iₚ stays within the safety range instead of continuing to rise to exceed the threshold current Iₚ limit. Afterwards, blocks 301 to 304 may be performed repeatedly, i.e., if the primary-side output current Iₚ has a tendency to continue to rise, the set current I_{o_set} continues to fall, to ensure that the primary-side output current Iₚ is kept at the threshold current I_{p_limit} or lower. When the process goes to t₁, the wireless charging enters the constant-voltage charging phase. During the constant-voltage charging phase from t₁ to t₂, the charging voltage Vₒ remains unchanged and the secondary-side charging current Iₒ and the primary-side output current Iₚ gradually reduce. The set current I_{o_set} will no longer decrease because the primary-side output current Iₚ has reduced below the threshold current I_{p_limit}.

In this way, it is ensured that the primary-side currents are constantly within the safety range while the power derating is implemented. In addition, the currents are not adversely affected by the changes in the coupling coefficient between the primary-side coil and the secondary-side coil, which effectively protects the components of the wireless charging system, including the primary-side power device.

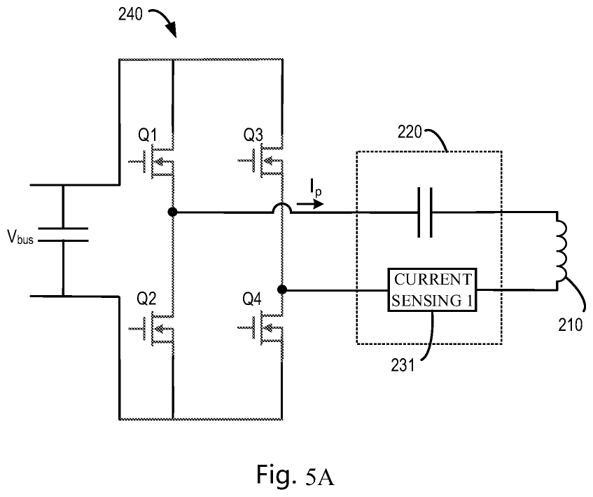

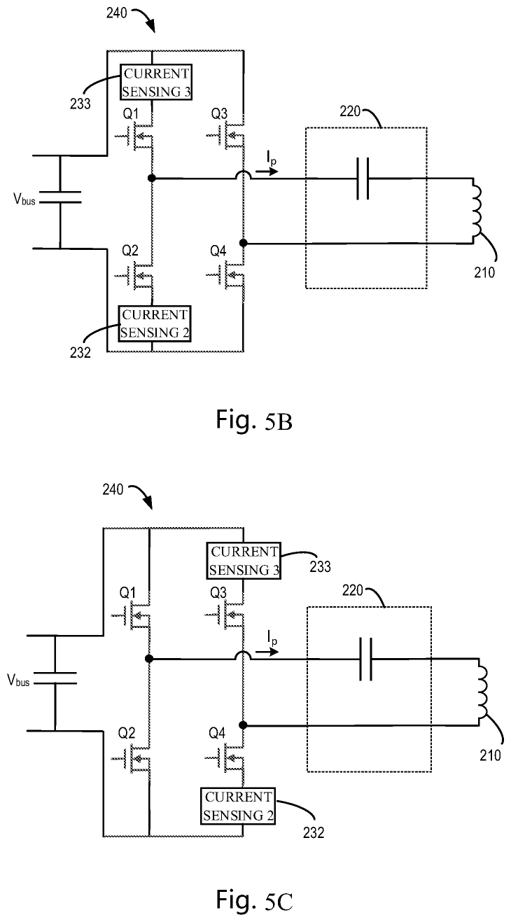

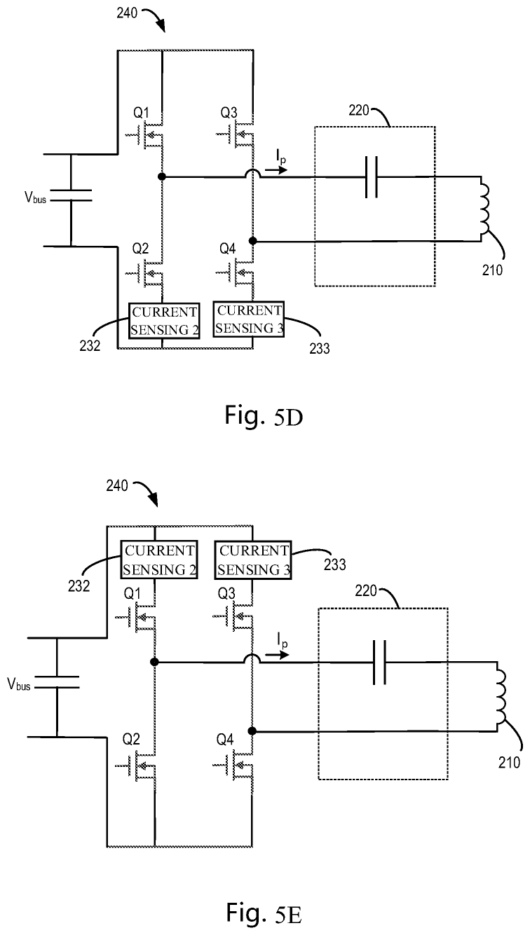

FIG. 5A illustrates a schematic diagram of a first arrangement of the sensing component 230 for sensing the primary-side output current Iₚ in accordance with embodiments of the present disclosure. In the first arrangement of FIG. 5A, a current sensing device 231 of the sensing component 230 is configured to sense currents in an output branch of the second power converter 240. For example, the current sensors or current transformers may be connected in series in the output branch of the second power converter 240, to sense the currents flowing by the output branch. As such, the secondary-side control device 160 may receive from the current sensing device 231 the sensing signals representing the primary-side output current Iₚ. In this way, the sensing signals of the output current Iₚ may be easily and directly obtained.

FIG. 5B illustrates a schematic diagram of a second arrangement of the sensing component 230 in accordance with embodiments of the present disclosure; FIG. 5C shows a schematic diagram of a third arrangement of the sensing component 230 in accordance with embodiments of the present disclosure; FIG. 5D illustrates a schematic diagram of a fourth arrangement of the sensing component 230 in accordance with embodiments of the present disclosure; and FIG. 5E shows a schematic diagram of a fifth arrangement of the sensing component 230 in accordance with embodiments of the present disclosure. In case that the second power converter 240 is a single-phase full-bridge converter, the sensing signals representing the primary-side output current Iₚ may be obtained based on the arrangements of the sensing device demonstrated by FIGS. 5B to 5E.

In the second arrangement of FIG. 5B, a current sensing device 232 of the sensing component 230 is configured to sense currents in a lower bridge arm (i.e., branch where the switching device Q2 is positioned) of a first bridge arm of the single-phase full-bridge converter, and a further current sensing device 233 of the sensing component 230 is configured to sense currents in an upper bridge arm (i.e., branch where the switching device Q1 is positioned) of the first bridge arm of the single-phase full-bridge converter. For example, the current sensor or the current transformer may be connected in series in the lower and upper bridge arms of the first bridge arm, to sense the currents flowing by the lower and upper bridge arms. Since the output branch of the second power converter 240 is connected to a node between the lower and upper bridge arms of the first bridge arm, the output current Iₚ of the second power converter 240 may be obtained and determined by obtaining the currents of the lower and upper bridge arms of the first bridge arm. In the third arrangement shown by FIG. 5C, the current sensing device 232 is configured to sense currents in a lower bridge arm (i.e., branch where the switching device Q4 is positioned) of a second bridge arm of the single-phase full-bridge converter, and a further current sensing device 233 is configured to sense currents in an upper bridge arm (i.e., branch where the switching device Q3 is positioned) of the second bridge arm of the single-phase full-bridge converter. Similarly, since the output branch of the second power converter 240 is connected to a node between the lower and upper bridge arms of the second bridge arm, the output current Iₚ of the second power converter 240 may also be determined by obtaining the currents of the lower and upper bridge arms of the second bridge arm.

In the fourth and fifth arrangements of FIGS. 5D and 5E, as the upper bridge arm (i.e., branch where the switching device Q1 is positioned) of the first bridge arm and the lower bridge arm (i.e., branch where the switching device Q4 is positioned) of the second bridge in the single-phase full-bridge inverter have symmetric currents, the current sensing device 233 in FIG. 5B may be moved from the upper bridge arm of the first bridge arm to the lower bridge arm of the second bridge arm to form the fourth arrangement, or the current sensing device 232 in FIG. 5C may be moved from the lower bridge arm of the second bridge arm to the upper bridge arm of the first bridge arm to form the fifth arrangement. By a combination of the current sensing devices in the fourth or fifth arrangements, the output current Iₚ of the second power converter 240 may also be sensed in real time to provide sensing signals representing the primary-side output current Iₚ.

In some embodiments of the present disclosure, the secondary-side control device 160 may obtain, based on the sensing signals representing the primary-side output current Iₚ, quasi-peak value signals or half-wave average signals corresponding to the sensing signals, and determine the output current Iₚ of the second power converter 240 on the basis of the quasi-peak value signals or the half-wave average signals. Specifically, the output current Iₚ in the resonance compensation network may be high-frequency signals approximate to sine wave. It may be relatively hard to obtain or determine effective values (root mean square, RMS) of such high-frequency sine wave signals for processing devices like digital signal processor (DSP). Accordingly, the magnitude of the output current Iₚ may be determined by determining the quasi-peak values or the half-wave average values of the sensing signals because the quasi-peak values or the half-wave average values are proportional to the RMS value for the high-frequency sine wave signals and are obtained more easily.

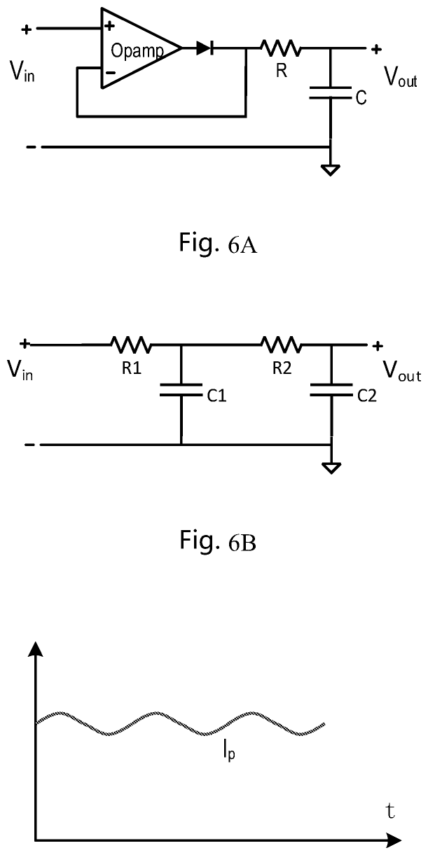

FIG. 6A illustrates an example schematic diagram of a quasi-peak value filter in accordance with embodiments of the present disclosure; and FIG. 6B shows an example schematic diagram of a half-wave average value filter in accordance with embodiments of the present disclosure. The sensing signals representing the primary-side output current Iₚ obtained from the sensing component 230 may be input to the filter shown by FIG. 6A or 6B as the input signal Vᵢₙ, and the output signal Vₒᵤₜ is output as the quasi-peak value signals or the half-wave average signals. It is to be understood that implementations of the quasi-peak value filter and the half-wave average value filter are not limited to this, and any other suitable ways may also be adopted for implementation.

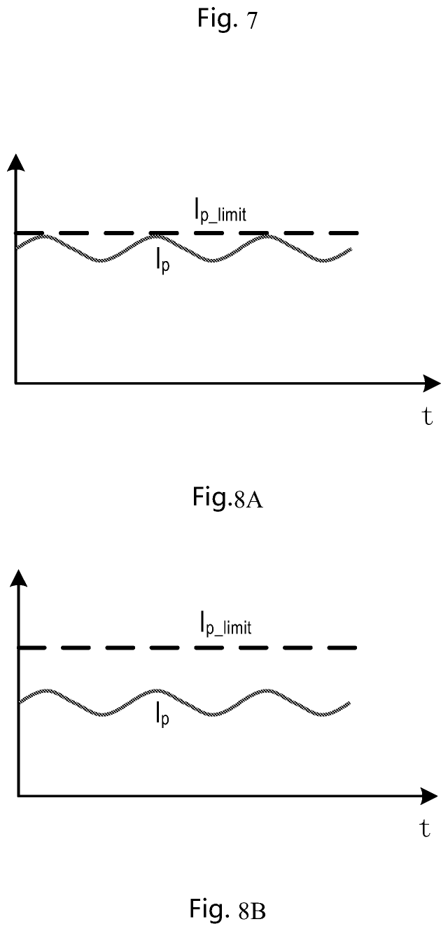

FIG. 7 illustrates an example waveform of the quasi-peak value signal or half-wave average signal in accordance with embodiments of the present disclosure. As shown in FIG. 7, in case that the power supply 2000 is a single-phase public grid, the bus voltage V_{bus} of the PFC unit 250 has twice power frequency ripples, so the quasi-peak value or the half-wave average of the sensing signals of the output current Iₚ also has twice power frequency ripples, i.e., the frequency of the quasi-peak value or the half-wave average is two-fold of the fundamental frequency of the AC power supply. After obtaining the quasi-peak value signal or the half-wave average signal of the output current Iₚ, the secondary-side control device 160 may sample the quasi-peak value signal or the half-wave average signal to determine a value characterizing the magnitude of the current Iₚ. As stated above, the determined value is compared with the preset threshold current I_{p_limit} to determine whether it is required limit the set current I_{o_set} of the charging current Iₒ.

In some embodiments, the secondary-side control device 160 may sample the quasi-peak value signal or the half-wave average signal to determine the maximum value and determine the output current Iₚ of the second power converter 240 based on the maximum value. Specifically, the maximum value of the quasi-peak value signal or the half-wave average signal may be determined, and the maximum value is determined as the final measurement value of the output current Iₚ for subsequent operations, i.e., the output current Iₚ is compared with the threshold current I_{p_limit}.

FIG. 8A illustrates a schematic diagram of comparison between the output current Iₚ and the threshold current I_{p_limit} during a period of time from t₀′ to t₁ of the second charging process, and FIG. 8B illustrates a schematic diagram of comparison between the output current Iₚ and the threshold current I_{p_limit} outside the period of time from t_{0′} to t₁ of the second charging process. As shown in FIGS. 8A and 8B, the maximum value of the quasi-peak value signal or the half-wave average signal may be determined as the output current Iₚ to limit the output current Iₚ below the threshold current I_{p_limit} at the greatest extent.

Those skilled in the art should understand respective steps of the above disclosed method can be implemented by a general-purpose computing apparatus. They may be integrated on a single computing apparatus or distributed in a network that includes a plurality of computing apparatuses. Optionally, they may be implemented by program codes executable by the computing apparatus. Accordingly, they may be stored in a storage device and executed by the computing apparatus, or separately fabricated as respective integrated circuit modules. Alternatively, a plurality of modules or steps therein is manufactured into a single integrated circuit module for implementation. Thus, the present disclosure is not limited to any particular combinations of hardware and software.

It is to be appreciated that although several apparatuses or sub-apparatuses of the device have been mentioned in the above detailed description, such classification is just exemplary and non-compulsory. In fact, in accordance with embodiments of the present disclosure, features and functions of the above described two or more apparatuses may be materialized in one apparatus. Conversely, features and functions of one apparatus described above may be further realized by a plurality of apparatuses.

The above described embodiments are optional and should not restrict the present disclosure. For those skilled in the art, the present disclosure may have various modifications and changes. Any modifications, equivalent substitutions and improves should be encompassed within the protection scope of the present disclosure as long as they are within the spirit and principle.

1. A control method for wireless charging, the control method comprising:
controlling a first power converter at a secondary side to charge a chargeable load at a first set current;
receiving a sensing signal representing an output current of a second power converter at a primary side; and
in response to the output current reaching or exceeding a threshold current, controlling the first power converter to charge the chargeable load at a second set current smaller than the first set current.

2. The control method of claim 1, further comprising:
in response to the output current being below the threshold current, controlling the first power converter to continue charging the chargeable load at the first set current.

3. The control method of claim 1, further comprising:
obtaining, based on the sensing signal, a quasi-peak value signal or a half-wave average signal corresponding to the sensing signal; and
determining, based on the quasi-peak value signal or the half-wave average signal, the output current of the second power converter.

4. The control method of claim 3, wherein determining, based on the quasi-peak value signal or the half-wave average signal, the output current of the second power converter comprises:
sampling the quasi-peak value signal or the half-wave average signal to determine a maximum value; and
determining, based on the maximum value, the output current of the second power converter.

5. The control method of claim 1, wherein receiving the sensing signal representing the output current of the second power converter at the primary side comprises:
receiving from a first current sensing device the sensing signal, wherein the first current sensing device is configured to sense a current in an output branch of the second power converter.

6. The control method of claim 1, wherein the second power converter is a single-phase full-bridge converter, and wherein receiving the sensing signal representing the output current of the second power converter at the primary side comprises:
receiving from a second current sensing device and a third current sensing device the sensing signal, wherein the second current sensing device is configured to sense a current in an upper bridge arm or a lower bridge arm of a first bridge arm of the single-phase full-bridge converter, and the third current sensing device is configured to sense a current in the lower bridge arm or the upper bridge arm of the first bridge arm, or sense a current in an upper bridge arm or a lower bridge arm of a second bridge arm of the single-phase full-bridge converter.

7. The control method of claim 1, further comprising:
adjusting the threshold current based on ambient conditions.

8. The control method of claim 7, wherein the ambient conditions comprise ambient temperature.

9. The control method of claim 1, wherein a charging coil at the secondary side is electromagnetically coupled to a charging coil at the primary side in a loose manner.

10. A wireless charging apparatus, comprising:
a charging coil for electromagnetically coupling to a primary-side charging coil at a secondary side;
a first power converter; and
a control device for controlling the first power converter, wherein the control device is configured to:
control the first power converter to charge a chargeable load at a first set current;
receive a sensing signal representing an output current of a second power converter at a primary side; and
in response to the output current reaching or exceeding a threshold current, control the first power converter to charge the chargeable load at a second set current smaller than the first set current.

11. The wireless charging apparatus of claim 10, wherein the control device is further configured to:
in response to the output current being below the threshold current, control the first power converter to continue charging the chargeable load at the first set current.

12. The wireless charging apparatus of claim 10, wherein the control device is further configured to:
obtain, based on the sensing signal, a quasi-peak value signal or a half-wave average signal corresponding to the sensing signal; and
determine, based on the quasi-peak value signal or the half-wave average signal, the output current of the second power converter.

13. The wireless charging apparatus of claim 12, wherein determining, based on the quasi-peak value signal or the half-wave average signal, the output current of the second power converter comprises:
sampling the quasi-peak value signal or the half-wave average signal to determine a maximum value; and
determining, based on the maximum value, the output current of the second power converter.

14. The wireless charging apparatus of claim 10, wherein receiving the sensing signal representing the output current of the second power converter at the primary side comprises:
receiving from a first current sensing device the sensing signal, wherein the first current sensing device is configured to sense a current in an output branch of the second power converter.

15. The wireless charging apparatus of claim 10, wherein the second power converter is a single-phase full-bridge converter, and wherein receiving the sensing signal representing the output current of the second power converter at the primary side comprises:
receiving from a second current sensing device and a third current sensing device the sensing signal, wherein the second current sensing device is configured to sense a current in an upper bridge arm or a lower bridge arm of a first bridge arm of the single-phase full-bridge converter, and the third current sensing device is configured to sense a current in the lower bridge arm or the upper bridge arm of the first bridge arm, or sense a current in an upper bridge arm or a lower bridge arm of a second bridge arm of the single-phase full-bridge converter.

16. The wireless charging apparatus of claim 10, wherein the control device is further configured to:
adjust the threshold current based on ambient conditions.

17. The wireless charging apparatus of claim 16, wherein the ambient conditions comprise ambient temperature.

18. The wireless charging apparatus of claim 10, wherein a charging coil at the secondary side is electromagnetically coupled to a charging coil at the primary side in a loose manner.

19. A wireless charging system, comprising:
a secondary-side charging apparatus; and
a primary-side charging apparatus, comprising:
a charging coil for electromagnetically coupling to a charging coil of the secondary-side charging apparatus at a primary side; and
a first power converter,
wherein the secondary-side charging apparatus comprises:
a charging coil for electromagnetically coupling to the primary-side charging coil at a secondary side:
a second power converter; and
a control device for controlling the second power converter, wherein the control device is configured to:
control the second power converter to charge a chargeable load at a first set current;
receive a sensing signal representing an output current of the first power converter at the primary side; and
in response to the output current reaching or exceeding a threshold current, control the second power converter to charge the chargeable load at a second set current smaller than the first set current.

20. (canceled)

21. The wireless charging system of claim 19, wherein the first power converter is a single-phase full-bridge converter, and the wireless charging system further comprises:
a second current sensing device configured to sense a current in an upper bridge arm or a lower bridge arm of a first bridge arm of the single-phase full-bridge converter, and
a third current sensing device configured to sense a current in the lower bridge arm or the upper bridge arm of the first bridge arm, or configured to sense a current in an upper bridge arm or a lower bridge arm of a second bridge arm of the single-phase full-bridge converter.
